(19) United States
(12) Patent Application Publication
(10) Pub. No.: US 2008/0265174 A1
(43) Pub. Date: Oct. 30, 2008

(54) CHARGED PARTICLE BEAM WRITING APPARATUS AND METHOD

(75) Inventors: Makoto HIRAMOTO, Tokyo (JP); Takashi Kamikubo, Tokyo (JP); Shuichi Tamamushi, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NuFlare Technology, Inc., Numazu-shi (JP)

(21) Appl. No.: 12/103,321

(22) Filed: Apr. 15, 2008

(30) Foreign Application Priority Data
Apr. 26, 2007 (JP) 2007-116388

(51) Int. Cl. H01J 3/26

(52) U.S. Cl. 250/398

(57) ABSTRACT

A charged particle beam writing apparatus includes an unit configured to irradiate a beam, a deflector configured to deflect the beam, a stage, on which a target is placed, configured to perform moving continuously, an lens configured to focus the beam onto the target, an unit configured to calculate a correction amount for correcting positional displacement of the beam on a surface of the target resulting from a first magnetic field caused by the lens and a second magnetic field caused by an eddy current generated by the first magnetic field and the moving of the stage, an unit configured to calculate a correction position where the positional displacement on the surface of the target has been corrected using the correction amount, and an unit configured to control the deflector so that the beam may be deflected onto the correction position.

### CROSS-REFERENCE TO RELATED APPLICATION

This application is based upon and claims the benefit of priority from the prior Japanese Patent Application No. 2007-116388 filed on Apr. 26, 2007 in Japan, the entire contents of which are incorporated herein by reference.

### BACKGROUND OF THE INVENTION

1. Field of the Invention

The present invention relates to a charged particle beam writing apparatus and method, and more particularly, to a writing apparatus and method for correcting positional displacement of a charged particle beam caused by a magnetic field resulting from an eddy current.

2. Related Art

Lithography technique that advances microminiaturization of semiconductor devices is extremely important in that only this process forms a pattern in Semiconductor manufacturing processes. In recent years, with an increase in high integration and large capacity of large-scale integrated circuits (LSI), a circuit line width required for the semiconductor devices is becoming narrower year by year. To form desired circuit patterns on these semiconductor devices, a master pattern (also called a mask or a reticle) with high precision is required. Then, the electron beam writing or “drawing” technique that has excellent resolution inherently is used for manufacturing such high precision master patterns.

FIG. 7 shows a schematic diagram illustrating operations of a variable-shaped type electron beam writing apparatus. As shown in the figure, the variable-shaped electron beam (EB) writing apparatus includes two aperture plates and operates as follows: A first or “upper” aperture plate 410 has a rectangular opening or “hole” 411 for shaping an electron beam 330. This shape of the rectangular opening may also be a square, a rhombus, a rhomboid, etc. A second or “lower” aperture plate 420 has a variable-shaped opening 421 for shaping the electron beam 330 that passed through the opening 411 of the first aperture plate 410 into a desired rectangular shape. The electron beam 330 emitted from a charge particle source 430 and having passed through the opening 411 is deflected by a deflector to penetrate part of the variable-shaped opening 421 of the second aperture plate 420 and thereby to irradiate a target workpiece or “sample” 340, which is mounted on a stage that is continuously moving in one predetermined direction (e.g. X direction) during the writing. Thus, a rectangular shape capable of passing through both the opening 411 and the variable-shaped opening 421 is written in a writing region of the target workpiece 340. This method of writing or “forming” a given shape by letting beams pass through both the opening 411 and the variable-shaped opening 421 is referred to as a “variable shaping” method.

Then, at the time of irradiating the target workpiece 340 placed on the stage with electron beams, the focus is adjusted by an objective lens. If apart of a magnetic field of this objective lens leaks to the stage, an eddy current arises in the conductive part on the stage. Since a magnetic field is generated on the stage by the eddy current, an error occurs at a writing position. There is disclosed in the reference an electrodynamics with respect to the eddy current (e.g., refer to “Numerical Electrodynamics, Fundamentals and Applications” by Toshihisa Honma, et al. Hokkaido University, edited by Japan Society for Simulation Technology, June, 2002, pp. 7-8, 12, 126-128).

As mentioned above, when the magnetic field of the objective lens reaches the conductive part on the stage, an eddy current arises. Then, there is a problem that writing position accuracy is deteriorated by a magnetic field generated by the eddy current. It may be possible to reduce the eddy current to some extent by taking the shape and material of parts on the stage into consideration, but however, there is a limit in modifying the design of the shape and material in manufacturing or in precision aspect. Moreover, reducing the eddy current by lowering the speed of the stage may be considered, but however, the writing time is increased in that case. Thus, there is a problem that a throughput falls.

### BRIEF SUMMARY OF THE INVENTION

An object of the present invention is to provide a writing apparatus and method capable of reducing writing positional displacement of beams.

In accordance with one aspect of the present invention, a charged particle beam writing apparatus includes an irradiation unit configured to irradiate a charged particle beam, a deflector configured to deflect the charged particle beam, a stage, on which a target workpiece is placed, configured to perform moving continuously, an objective lens configured to focus the charged particle beam onto the target workpiece, a correction amount calculation unit configured to calculate a correction amount for correcting positional displacement of the charged particle beam on a surface of the target workpiece resulting from a first magnetic field caused by the objective lens and a second magnetic field caused by an eddy current generated by the first magnetic field and the moving of the stage, a correction position calculation unit configured to calculate a correction position where the positional displacement on the surface of the target workpiece has been corrected using the correction amount, and a deflection control unit configured to control the deflector so that the charged particle beam may be deflected onto the correction position.

In accordance with another aspect of the present invention, a charged particle beam writing method includes virtually dividing a writing space above a stage into a plurality of mesh-like small spaces, calculating an eddy current generated by a first magnetic field caused by an objective lens for focusing a charged particle beam onto a target workpiece and movement of the stage on which the target workpiece is placed, for each of the plurality of mesh-like small spaces, calculating a second magnetic field generated by the eddy current, for each of the plurality of mesh-like small spaces, synthesizing the first and the second magnetic fields, calculating a displacement amount of a charged particle, based on a third magnetic field obtained by synthesizing the first and the second magnetic fields, for each of the plurality of mesh-like small spaces, calculating a correction amount for correcting positional displacement on a surface of the target workpiece, based on the displacement amount of the charged particle of each of the plurality of mesh-like small spaces, and writing a predetermined pattern on the surface of the target workpiece by irradiating the charged particle beam onto a position where the positional displacement on the surface of the target workpiece is corrected using the correction amount.

In accordance with another aspect of the present invention, a charged particle beam writing method includes calculating a correction amount for correcting positional displacement of a charged particle beam on a surface of a target workpiece resulting from a first magnetic field caused by an objective lens for focusing the charged particle beam onto the target workpiece, and a second magnetic field caused by an eddy current generated by the first magnetic field and a movement of a stage on which the target workpiece is placed, calculating a correction position where the positional displacement on the surface of the target workpiece has been corrected using the correction amount, and writing a predetermined pattern on the surface of the target workpiece by irradiating the charged particle beam onto the correction position.

### BRIEF DESCRIPTION OF THE DRAWINGS

FIG. 1 shows a schematic diagram illustrating a structure of a pattern writing apparatus described in Embodiment 1;

FIG. 2 illustrates a state of a stage movement described in Embodiment 1;

FIG. 3 shows a schematic diagram illustrating a generation mechanism of a magnetic field and an eddy current described in Embodiment 1;

FIG. 4 shows a schematic diagram illustrating positional displacement of a pattern resulting from a magnetic field described in Embodiment 1;

FIG. 5 is a flowchart showing the main steps of a writing method described in Embodiment 1;

FIG. 6 shows a schematic diagram illustrating a method for correcting positional displacement described in Embodiment 1; and

FIG. 7 shows a schematic diagram illustrating operation of a conventional variable-shaped electron beam pattern writing apparatus.

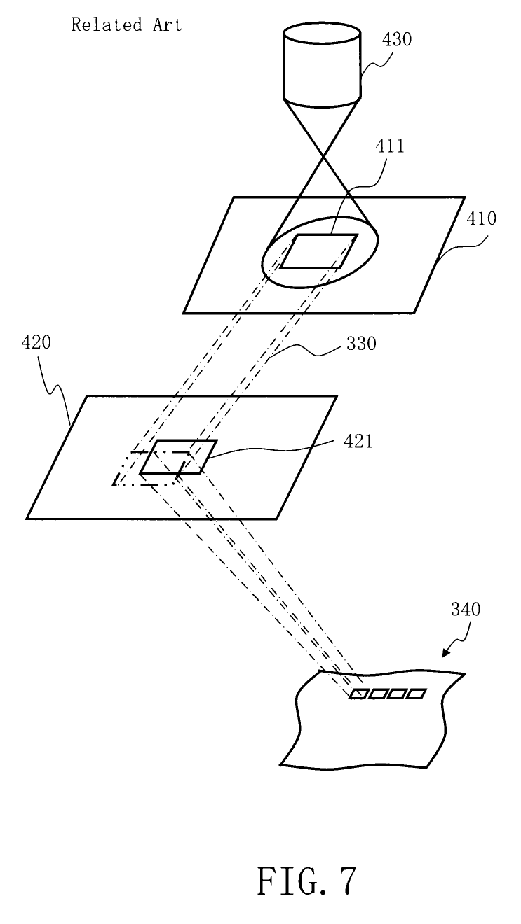

### DETAILED DESCRIPTION OF THE INVENTION

In the following Embodiments, a structure utilizing an electron beam, as an example of a charged particle beam, will be described. The charged particle beam is not limited to the electron beam, but may be a beam using other charged particle, such as an ion beam.

### Embodiment 1

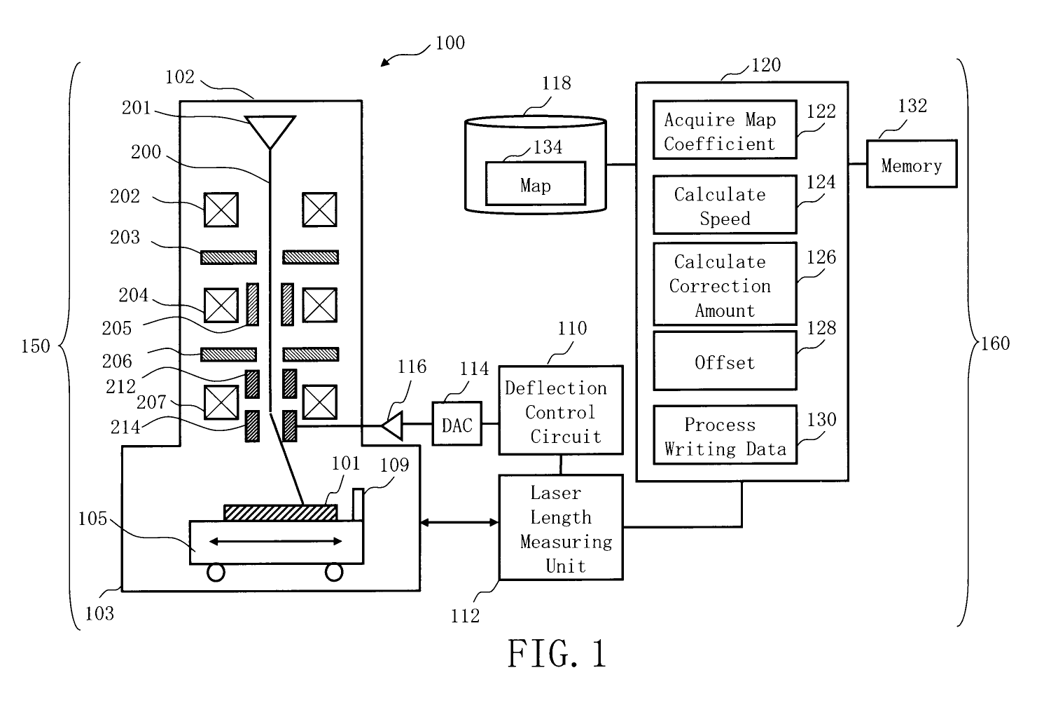

FIG. 1 shows a schematic diagram illustrating a structure of a pattern writing apparatus according to Embodiment 1. In FIG. 1, a pattern writing apparatus 100 includes a writing unit 150 and a control unit 160. The pattern writing apparatus 100 serves as an example of a charged particle beam writing apparatus. The pattern writing apparatus 100 writes a desired pattern onto a target workpiece 101. The control unit 160 includes a deflection control circuit 110, a laser length measuring unit 112, a digital-analog converter (DAC) 114, an amplifier 116, a magnetic disk drive 118, a control calculator 120, and a memory 132. The writing unit 150 includes an electron lens barrel 102 and a writing chamber 103. In the electron lens barrel 102, there are arranged an electron gun assembly 201, an illumination lens 202, a first aperture plate 203, a projection lens 204, a deflector 205, a second aperture plate 206, an objective lens 207, a sub-deflector 212, and a main deflector 214. In the writing chamber 103, there is an XY stage 105 which is movably arranged. On the XY stage 105, there are placed the target workpiece 101 and a mirror 109. As the target workpiece 101, for example, an exposure mask for exposing or “transferring and printing” a pattern onto a wafer is included. This mask includes a mask blank in which no patterns are formed, for example.

Moreover, in the magnetic disk drive 118, a correlation map 134 is stored. In the control calculator 120, processing of functions, such as a map coefficient acquiring unit 122, a speed calculation unit 124, a correction amount calculation unit 126, an offset unit 128, and a writing data processing unit 130, is performed. While structure elements necessary for explaining Embodiment 1 are shown in FIG. 1, it should be understood that other structure elements generally necessary for the pattern writing apparatus 100 are also included.

In FIG. 1, processing of functions, such as the map coefficient acquiring unit 122, the speed calculation unit 124, the correction amount calculation unit 126, the offset unit 128, and the writing data processing unit 130 is performed by the control calculator 120 serving as a computer. However, it is not restricted thereto, and may be executed by hardware, such as an electric circuit. Alternatively, it may be executed by a combination between hardware of an electric circuit and software, or a combination of hardware and firmware.

An electron beam 200 emitted from an electron gun assembly 201, being an example of an irradiation unit, irradiates the whole of a first aperture plate 203 having a rectangular opening or “hole” by an illumination lens 202, for example. This shape of the rectangular opening may also be a square, rhombus, a rhomboid, etc. At this point, the electron beam 200 is shaped to be a rectangle. Then, after having passed through the first aperture plate 203, the electron beam 200 of a first aperture image is projected onto a second aperture plate 206 by a projection lens 204. The position of the first aperture image on the second aperture plate 206 is controlled by a deflector 205, and thereby the shape and size of the beam can be changed. After having passed through the second aperture plate 206, the electron beam 200 of a second aperture image is focused by an objective lens 207 and deflected by a main deflector 214 and a sub-deflector 212 which are controlled by the deflection control circuit 110, to reach a desired position on a target workpiece 101 placed on an XY stage 105 continuously moving. The writing data is processed by the writing data processing unit 130, and converted into shot data. A predetermined pattern is written at a desired position based on the shot data.

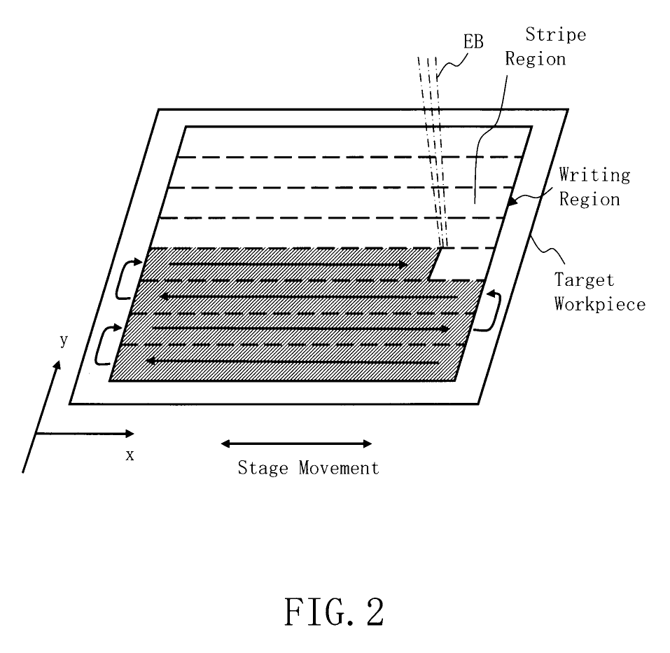

FIG. 2 illustrates a state of a stage movement described in Embodiment 1. When writing on the target workpiece 101, the electron beam 200 irradiates one of stripe regions of the target workpiece 101, made by virtually dividing the writing (exposure) surface into a plurality of strip-like regions, wherein the electron beam 200 can be deflected, while the XY stage 105 continuously moving in the X direction, for example. The movement of the XY stage 105 in the X direction is a continuous movement. Simultaneously, the shot position of the electron beam 200 is made to be in accordance with the movement of the stage. Writing time can be shortened by performing the continuous movement. After finishing writing one stripe region, the XY stage 105 is moved in the Y direction by step feeding. Then, the writing operation of the next stripe region is performed in the X direction (reverse direction). By performing the writing operation of each stripe region in a zigzag manner, the movement time of the XY stage 105 can be shortened.

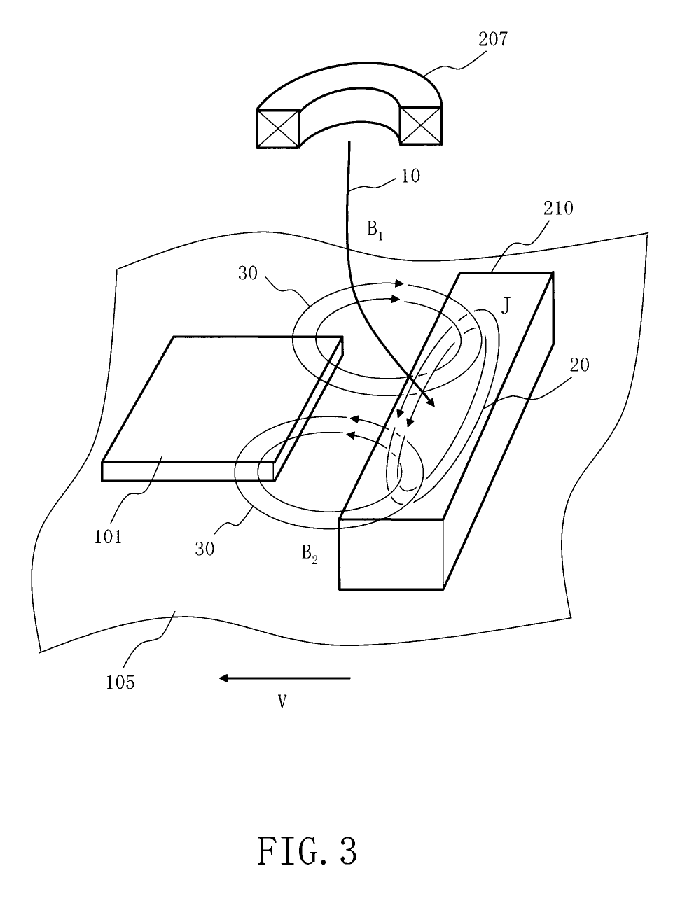

FIG. 3 shows a schematic diagram illustrating a generation mechanism of a magnetic field and an eddy current described in Embodiment 1. In the writing apparatus 100, if a part of a magnetic field 10 of the electron lens, such as an objective lens 207, leaks onto the XY stage 105, an eddy current 20 occurs in a conductive part 210 on the XY stage 105 by the movement of the XY stage 105 at a speed V. Then, when the eddy current 20 occurs on the XY stage 105, a magnetic field 30 caused by the eddy current 20 occurs on the XY stage 105. Receiving the influence of these magnetic fields 10 and 30, orbit displacement arises in the orbit of an electron in the electron beam 200.

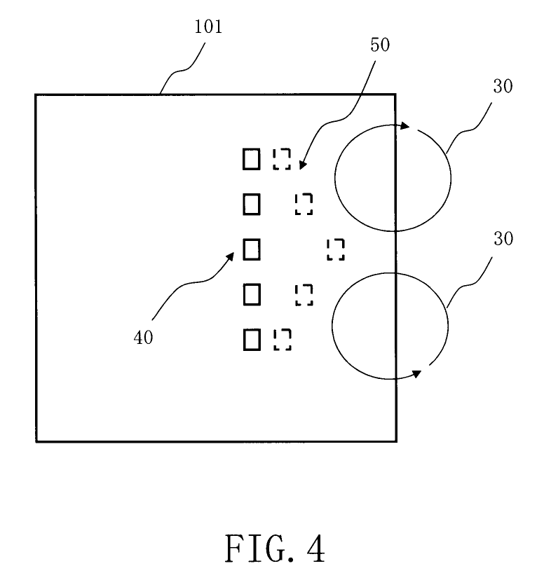

FIG. 4 shows a schematic diagram illustrating positional displacement of a pattern caused by a magnetic field described in Embodiment 1. When the magnetic fields 10 and 30 are not generated, i.e., when the eddy current 20 is not generated, patterns 40 are located in a line on the target workpiece 101. However, the emitted electron beam 200 is bent by a magnetic flux density B₁ of the magnetic field 10 and a magnetic flux density B₂ of the magnetic field 30. Therefore, the position of the pattern written by the bent beam becomes displaced or “deviated” like a pattern 50. In Embodiment 1, writing is performed so that this positional displacement may be corrected.

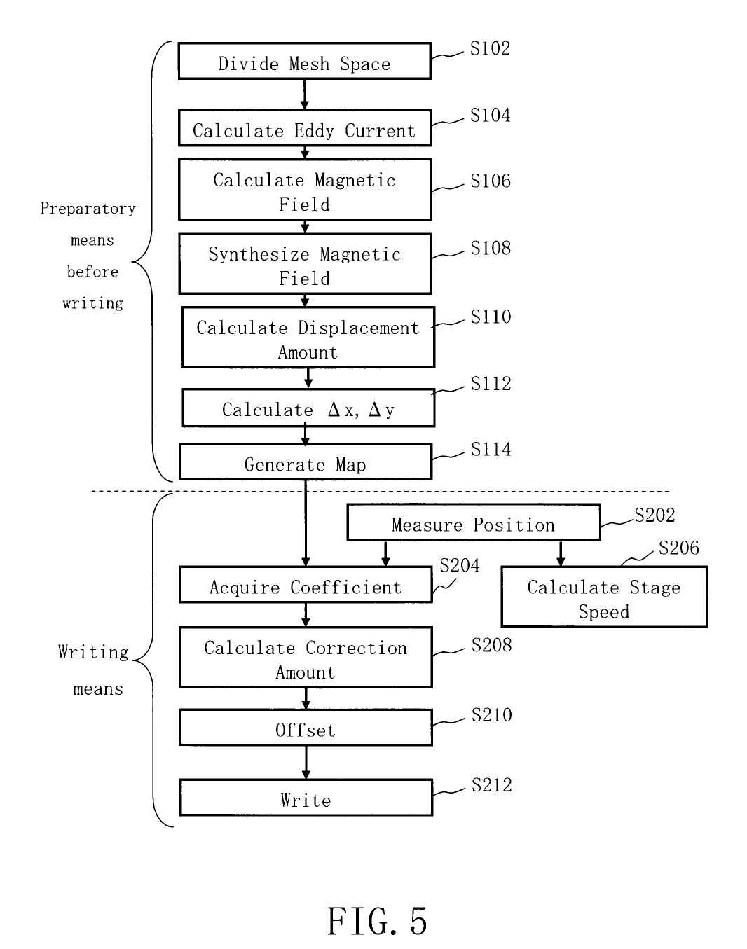

FIG. 5 is a flowchart showing the main steps of a writing method described in Embodiment 1. In FIG. 5, the writing method according to Embodiment 1 executes a series of steps as a preparatory step before writing: a mesh space dividing step (S102), an eddy current calculation step (S104), a magnetic field calculation step (S106), a magnetic field synthesis step (S108), a displacement amount calculation step (S110), a correction amount calculation step (S112), and a map generation step (S114). The writing method executes a series of steps as a writing step: a position measuring step (S202), a coefficient acquiring step (S204), a stage speed calculation step (S206), a correction amount calculation step (S208), an offset step (S210), and a writing step (S212).

In the step S102, as a mesh space dividing step, the writing space above the XY stage 105 is virtually divided into a plurality of mesh-like mesh spaces (small spaces). For example, it is preferable to virtually divide a space from near the installation position of the objective lens 207 to the writing surface of the target workpiece 101 into mesh spaces.

In the step S104, as an eddy current calculation step, the eddy current 20 generated by the magnetic field 10 (first magnetic field) caused by the objective lens 207 and the movement of the XY stage 105 is calculated for each mesh space. An electric field E in each mesh space, specified by boundary conditions, such as a shape of the conductive part 210, can be expressed by the Maxwell equation (1) shown below by using a vector of the magnetic flux density B₁ of the magnetic field 10, a vector of rotation ∇, and a time t.

$$\vec{∇} \times \vec{E} = - \frac{\partial {\vec{B}}_{1}}{\partial t} \qquad ( 1 )$$

Then, a current J of the eddy current 20 can be expressed by the equation (2) shown below, by using the calculated electric field E and an electrical conductivity σ specified by material etc. of the conductive part 210 that generates the eddy current 20.

[symbol]

=σ [symbol] (2)

Thus, the current J of the eddy current 20 generated in the conductive part 210 can be calculated by using the shape, material, position, etc. of the conductive part 210, as a parameter.

In the step S106, as a magnetic field calculation step, the magnetic field 30 (second magnetic field) generated by the eddy current 20 is calculated for each mesh space. The magnetic flux density B₂ of the magnetic field 30 in each mesh space can be expressed by the equation (3) based on the Bio-Savart law shown below, by using the current J of the eddy current 20, a vector of a direction s of the current, a vector of the position r, and permeability mu₀ in vacuum.

$${{B}^{ϖ}}_{2} = \frac{{μ}_{0} J}{4 π} \int \frac{d {s}^{ϖ} \times {r}^{ϖ}}{{r}^{3}} \qquad ( 3 )$$

In the step S108, as a synthesis step, the magnetic field 10 and the magnetic field 30 are synthesized. The magnetic flux density B₀ of the synthetic magnetic field (third magnetic field), which has been synthesized, can be expressed by the following equation (4), wherein the magnetic flux density B₂ of the magnetic field 30 is added to the magnetic flux density B₁ of the magnetic field 10.

\vec{B}₀=\vec{B}₁+\vec{B}₂ (4)

In the step S110, as a displacement amount calculation step of an electron, a displacement amount of the electron based on the synthetic magnetic field is calculated for each mesh space. The position r of an electron at a certain time t can be expressed by the equation (5) shown below, by using a vector of the magnetic flux density B₀ of the synthetic magnetic field, a vector of the speed v of the electron, a quantity m of the electron, and an electric charge e. A displacement amount of the electron beam 200 in writing each position on the surface of the target workpiece 101 is calculated by obtaining the position of the electron in order for each mesh space.

$$m \frac{{d}^{2} {r}^{ϖ}}{d {t}^{2}} = - e {v}^{ϖ} \times {{B}^{ϖ}}_{0} \qquad ( 5 )$$

In the step S112, as a correction amount calculation step, a correction amount (ΔX, ΔY) for correcting the calculated displacement amount of the electron beam 200 in writing each position on the surface of the target workpiece 101 is calculated.

In the step S114, as a map generation step, a correlation map 134 is generated in which each coefficient (A_{i, j}, B_{i, j}, C_{i, j}, D_{i, j}) of the following approximate expressions (6-1) and (6-2) for approximating correction amounts calculated at a plurality of positions on the surface of the target workpiece 101, wherein the correction amount is obtained from the approximate expressions (6-1) and (6-2) by using the stage speed V as a factor, is related and defined with respect to each position on the surface of the target workpiece 101. Since the current J of the eddy current 20 is in proportion to the stage speed V, the magnetic flux density B₂ of the magnetic field 30 is also proportional to the stage speed V. As a result, the correction amount (ΔX, ΔY) of the electron beam 200 can be approximated using the stage speed V as a factor. A stage speed in the x direction is defined to be Vₓ and a stage speed in the y direction is defined to be V_{y}. Coordinates of each position on the surface of the target workpiece 101 are expressed by (i, i).

ΔX=A_{i,j}·Vₓ+C_{i,j}·V_{y} (6-1)

ΔY=B_{i,j}·Vₓ+D_{i,j}·V_{y} (6-2)

The correlation map 134 generated as described above is stored in the magnetic disk drive 118. Then, next, it goes to the actual writing step.

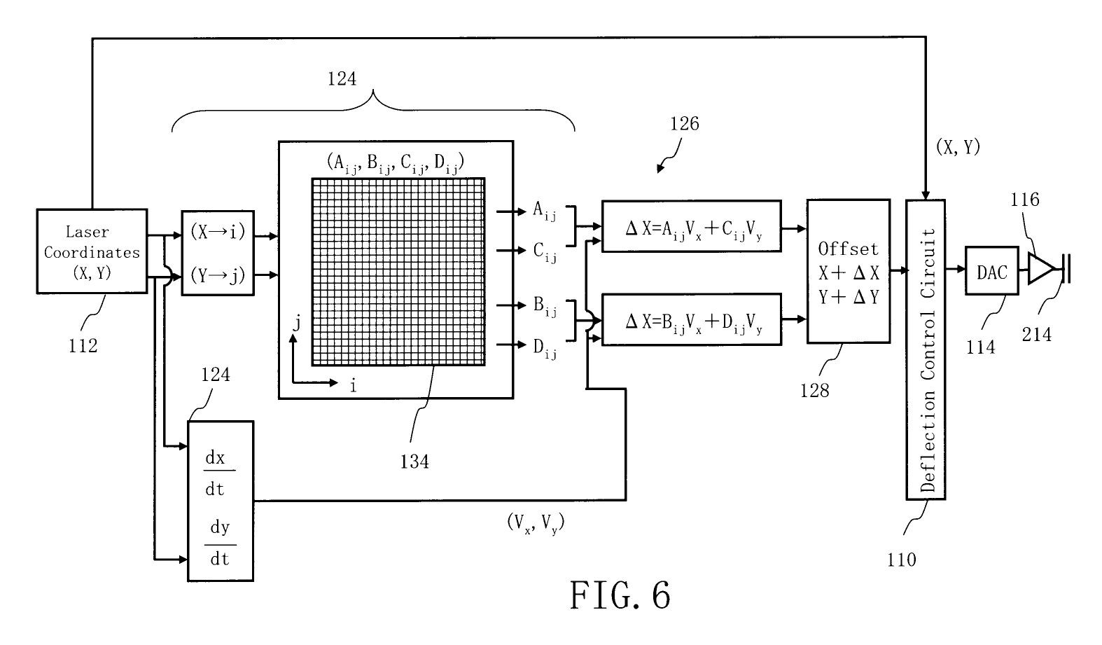

FIG. 6 shows a schematic diagram illustrating a method for correcting positional displacement described in Embodiment 1. In the step S202, as a position measuring step, the laser length measuring unit 112 measures the position (X, Y) of the XY stage 105 by receiving a reflected light of the laser irradiating the mirror 109 in real time in accordance with the advance of writing.

In the step S204, as a coefficient acquiring step, the map coefficient acquiring unit 122 first calculates the coordinates (i, j) on the writing surface, from the laser coordinates (X, Y) of the XY stage 105 in real time during writing. Then, the map coefficient acquiring unit 122 reads the correlation map 134 from the magnetic disk drive 118 in real time, and acquires each coefficient (A_{i, j}, B_{i, j}, C_{i, j}, D_{i, j}) of the coordinates (i, j)

In the step S206, as a stage speed calculation step, the speed calculation unit 124, during writing, differentiates the laser coordinates (X, Y) of the XY stage 105 in real time in accordance with the advance of writing, to obtain the stage speed Vₓ in the x direction and the stage speed V_{y} in the y direction.

In the step S208, as a correction amount calculation step, the correction amount calculation unit 126 calculates a correction amount (ΔX, ΔY) for correcting positional displacement of the electron beam 200 at the coordinates (i, j) on the surface of the target workpiece 101. During writing, the correction amount calculation unit 126 inputs the stage speed (Vₓ, V_{y}) and each coefficient (A_{i, j}, B_{i, j}, C_{i, j}, D_{i, j}) in real time in accordance with the advance of the writing. The correction amount (ΔX, ΔY) can be calculated according to the equations (6-1) and (6-2).

In the step S210, as an offset step, the offset unit 128 offsets the position for deflecting the electron beam 200 by adding the correction amount ΔX to the laser coordinate X in the x direction and adding the correction amount ΔY to the laser coordinate Y in the y direction. In this way, the position (X+ΔX, Y+ΔY) obtained by correcting the displacement amount on the surface of the target workpiece is calculated. The offset unit 128 serves as an example of the correction position calculation unit.

In the step S212, as a writing step, the writing unit 150 irradiates the electron beam 200 onto the correction position (X+ΔX, Y+ΔY) obtained by correcting the displacement amount on the surface of the target workpiece 101, to write a predetermined pattern on the surface of the target workpiece 101. Specifically, during writing, the correction position (X+ΔX, Y+ΔY) which has been offset is set in the deflection control circuit 110 in real time in accordance with the advance of writing. The deflection control circuit 110 outputs a digital control signal to the DAC 114. The digital control signal is converted into an analog voltage signal in the DAC 114. The analog voltage signal is amplified by the amplifier 116, and applied to the main deflector 214. As a result, the position (position of the main deflection) deflected by the main deflector 214 is corrected to be the correction position (X+ΔX, Y+ΔY). Thus, the deflection control circuit 110 can control the main deflector 214 so that the electron beam 200 bent by the magnetic field 30, etc. resulting from the eddy current 20 is deflected to be the correction position.

According to Embodiment 1, as mentioned above, since the position affected by the magnetic field caused by the eddy current can be corrected, displacement of the beam writing position can be reduced without decreasing the speed of the stage. Therefore, it becomes possible to write without reducing the stage speed. Thus, reduction of throughput can be suppressed. Moreover, since positional displacement caused by an eddy current can be estimated beforehand, the quality of material of parts can be selected depending upon required precision, thereby resulting in cost reduction.

In the above description, contents of processing or operation of what is represented by the word “unit” or “step” may be configured by software programs executed by the computer system, or may be configured by hardware. Alternatively, they may be configured by any combination of software, hardware and/or firmware. When constituted by a program, the program is stored in a computer-readable recording medium, such as the magnetic disk drive 118, a magnetic tape unit (not shown), FD, DVD, CD, or ROM (Read Only Memory).

In FIG. 1, the control calculator 120 may be connected, through a bus (not shown), to RAM (Random Access Memory), ROM, and a magnetic disk (HD), which are examples of a storage device, a keyboard (K/B) and a mouse, which are examples of an input means, monitor and a printer, which are examples of an output means, or an external interface (I/F), FD, DVD, CD, etc. which are examples of an input/output means.

While the embodiments have been described above with reference to specific examples, the present invention is not restricted to these specific examples.

While description of the apparatus structure, control method, etc. not directly required for explaining the present invention is omitted, it is possible to suitably select and use some or all of them when needed. For example, although the structure of a control unit for controlling the pattern writing apparatus 100 is not described, it should be understood that a necessary control unit structure can be selected and used appropriately.

In addition, any other method for writing with a charged particle beam and apparatus thereof that include elements of the present invention and that can be appropriately modified by those skilled in the art are included within the scope of the present invention.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A charged particle beam writing apparatus comprising:
an irradiation unit configured to irradiate a charged particle beam;
a deflector configured to deflect the charged particle beam;
a stage, on which a target workpiece is placed, configured to perform moving continuously;
an objective lens configured to focus the charged particle beam onto the target workpiece;
a correction amount calculation unit configured to calculate a correction amount for correcting positional displacement of the charged particle beam on a surface of the target workpiece resulting from a first magnetic field caused by the objective lens and a second magnetic field caused by an eddy current generated by the first magnetic field and the moving of the stage;
a correction position calculation unit configured to calculate a correction position where the positional displacement on the surface of the target workpiece has been corrected using the correction amount; and
a deflection control unit configured to control the deflector so that the charged particle beam may be deflected onto the correction position.

2. The apparatus according to claim 1, further comprising:
a storage unit configured to store a correlation map in which a coefficient of an approximate expression for approximating the correction amount at each of a plurality of positions on the surface of the target workpiece, wherein the correction amount is obtained from the approximate expression by using a speed of the stage as a factor, is related and defined with respect to the each of the plurality of positions; and
a speed calculation unit configured to calculate the speed of the stage,
wherein the correction amount calculation unit calculates the correction amount by using the speed of the stage calculated by the speed calculation unit as the factor, using the coefficient stored in the storage unit.

3. The apparatus according to claim 2, wherein the correction amount calculation unit calculates the correction amount in real time in accordance with the advance of writing, using the correlation map.

4. A charged particle beam writing method comprising:
virtually dividing a writing space above a stage into a plurality of mesh-like small spaces;
calculating an eddy current generated by a first magnetic field caused by an objective lens for focusing a charged particle beam onto a target workpiece and movement of the stage on which the target workpiece is placed, for each of the plurality of mesh-like small spaces;
calculating a second magnetic field generated by the eddy current, for each of the plurality of mesh-like small spaces;
synthesizing the first and the second magnetic fields;
calculating a displacement amount of a charged particle, based on a third magnetic field obtained by synthesizing the first and the second magnetic fields, for each of the plurality of mesh-like small spaces;
calculating a correction amount for correcting positional displacement on a surface of the target workpiece, based on the displacement amount of the charged particle of each of the plurality of mesh-like small spaces; and
writing a predetermined pattern on the surface of the target workpiece by irradiating the charged particle beam onto a position where the positional displacement on the surface of the target workpiece is corrected using the correction amount.

5. The method according to claim 4 further comprising:
after calculating the correction amount, generating a correlation map in which a coefficient of an approximate expression for approximating the correction amount, wherein the correction amount is obtained from the approximate expression by using a speed of the stage as a factor, is defined with respect to each of a plurality of positions on the surface of the target workpiece; and
newly calculating the correction amount, using the correlation map,
wherein the correction amount newly calculated is used when performing the writing.

6. The method according to claim 5 further comprising:
measuring a position of the stage; and
calculating a speed of the stage based on the position of the stage.

7. The method according to claim 6, wherein the speed of the stage is used as a factor in the newly calculating the correction amount.

8. A charged particle beam writing method comprising:
calculating a correction amount for correcting positional displacement of a charged particle beam on a surface of a target workpiece resulting from a first magnetic field caused by an objective lens for focusing the charged particle beam onto the target workpiece, and a second magnetic field caused by an eddy current generated by the first magnetic field and a movement of a stage on which the target workpiece is placed;
calculating a correction position where the positional displacement on the surface of the target workpiece has been corrected using the correction amount; and
writing a predetermined pattern on the surface of the target workpiece by irradiating the charged particle beam onto the correction position.

9. The method according to claim 8 further comprising:
after calculating the correction amount, generating a correlation map in which a coefficient of an approximate expression for approximating the correction amount, wherein the correction amount is obtained from the approximate expression by using a speed of the stage as a factor, is defined with respect to each of a plurality of positions on the surface of the target workpiece; and
newly calculating the correction amount, using the correlation map,
wherein the correction amount newly calculated is used when calculating the correction position.

10. The method according to claim 9 further comprising:
measuring a position of the stage; and
calculating a speed of the stage based on the position of the stage.

11. The method according to claim 10, wherein the speed of the stage is used as a factor in the newly calculating the correction amount.
